(19) United States
(12) Patent Application Publication
(10) Pub. No.: US 2025/0252436 A1
(43) Pub. Date: Aug. 7, 2025

(54) Active Metadata and Reinforcement Learning to Improve TPS Processing

(71) Applicant: Bank of America Corporation, Charlotte, NC (US)

(72) Inventors: Maneesh Kumar Sethia, Hyderabad (IN); Gowri Sundar Suriyanarayanan, Chennai (IN); Sivashalini Sivajothi, Chennai (IN); Ashokkumar M, Chennai (IN); Shameera Roohin Mohammed Nasrullah, Chengalpattu (IN); Parameswari K, Chennai (IN)

(21) Appl. No.: 18/434,098

(22) Filed: Feb. 6, 2024

(51) Int. Cl. G06Q 20/40; G06N 3/092

(52) U.S. Cl. CPC G06Q 20/401; G06N 3/092

(57) ABSTRACT

Innovative systems and methods address the challenges in blockchain transaction processing, particularly in Proof of Work (POW) and Proof of Minting (POM) consensus mechanisms. These challenges encompass slow transaction processing, network congestion, high resource consumption, transaction prioritization issues, scalability limitations, environmental concerns, and the trade-off between security and efficiency. To mitigate these issues, innovative solutions combine active metadata and reinforcement learning to optimize cryptocurrency transaction processing, enhancing the Transactions Per Second (TPS) rate in Crypto Mining and Minting. Users initiate transactions, which are queued with detailed information. Active metadata efficiently processes and assigns transactions, while reinforcement learning dynamically adjusts block sizes based on transaction sizes. This streamlines transaction processing, incentivizes efficient block creation, and improves overall blockchain network performance. Key features include advanced queue management, dynamic block sizing, and a TPS-based reward system. The inventions revolutionize cryptocurrency transaction processing, promoting efficiency, fairness, and sustainability in blockchain networks.

### TECHNICAL FIELD

The present disclosure relates to Data Processing: Artificial Intelligence and Data Processing: Database and File Management or Data Structures because they encapsulate the core technological aspects of the invention: artificial intelligence (specifically reinforcement learning) and advanced data management (through active metadata) in order to maximize the number of transactions that a network can process in a single second as an indication of how efficiently the network can handle transaction loads.

### DESCRIPTION OF THE RELATED ART

There are fundamental problems in cryptocurrency transactions related to the transaction per second (TPS) rate. The issue lies in the significant difference between traditional financial transactions and cryptocurrency transactions. In traditional systems, transactions are processed almost immediately, but in the cryptocurrency world, transactions take longer due to extensive validations and dependency on block creators' approval.

The problem is compounded by block creators' preference for larger transactions. Since the processing charge for smaller transactions is lower, and they consume a similar amount of block space as larger transactions, block creators tend to prioritize larger transactions to maximize their processing costs. This leads to smaller transactions either being delayed (sometimes for hours or weeks) or requiring higher processing costs to expedite. This system disproportionately affects users with smaller transactions, as they face longer waiting times or higher costs to process their transactions promptly. The invention aims to address this inefficiency and inequity in the transaction processing of cryptocurrency systems.

For reference, Proof of Work (PoW) is a consensus mechanism used in blockchain technology to validate transactions and add new blocks to the chain. In PoW, miners compete to solve complex cryptographic puzzles. The first miner to solve the puzzle gets the right to add a new block to the blockchain and is rewarded with cryptocurrency. This process requires significant computational power and energy, contributing to its security but also raising concerns about efficiency and environmental impact. PoW is notable for its role in networks like Bitcoin. Proof of Minting (POM) is a less common blockchain consensus mechanism compared to Proof of Work or Proof of Stake (POS). The concept of POM generally revolves around a process where the creation (or minting) of new blocks in a blockchain is based on various factors other than complex computational work (as in PoW) or stake ownership (as in PoS). The specifics of Proof of Minting can vary depending on the particular blockchain implementation. It's designed to be more energy-efficient than PoW and may involve unique methodologies for validating transactions and adding new blocks to the blockchain.

At a high level, in PoW, creating a block can be time-consuming, and the high computational resource requirement often leads to delays in transactions reaching the beneficiary. Additionally, block creators may prioritize transactions with larger crypto amounts for higher processing costs, disadvantaging smaller transactions. Relatedly, at a high level, in PoM of be slow, especially for smaller transactions. Validators might face delays due to network issues, node availability, or personal unavailability (e.g., being on vacation), leading to further transaction processing delays.

More specifically, the multifaceted problems in cryptocurrency systems, especially in proof of work (PoW) and proof of minting (POM), extend across several dimensions:
a. Slow Transaction Processing: The processing speed of transactions is a critical bottleneck. In PoW and POM systems, the time it takes to validate and add a transaction to the blockchain can be lengthy, especially during high network demand periods. This slowness is partly due to the complex cryptographic puzzles that need to be solved in PoW systems. Blockchains, particularly under high network demand, struggle with processing speeds, resulting in delays. This is exacerbated during peak transaction periods, where the volume of transactions can overwhelm the system's ability to process them efficiently.
b. Network Congestion: As more users join and use a blockchain network, the volume of transactions increases. This can lead to network congestion, where the blockchain struggles to process transactions quickly due to the sheer volume of data. Stated differently, as the user base and transaction volume grow, blockchain networks can become congested. This congestion can significantly slow down the processing of transactions, further exacerbating the issue of slow transaction times.
c. High Resource Consumption and Resource Intensiveness of POW: PoW requires substantial computational power, leading to significant energy consumption. This not only increases operational costs but also raises environmental concerns due to the high carbon footprint associated with energy use. Stated differently, PoW, in particular, requires significant computational power and energy, contributing to high operational costs and environmental concerns. This resource-intensive nature limits scalability and sustainability.
d. Transaction Prioritization Issues and Inequitable Transaction Prioritization: Systems often prioritize transactions with higher costs, leading to longer wait times for transactions with lower costs. This creates a disparity where users willing to pay more are serviced faster, while others experience delays. In other words, in current systems, transactions with higher costs are often prioritized, leading to longer waiting times for smaller, lower-cost transactions. This creates an unequal playing field where users willing to pay more can expedite their transactions, while others are left waiting.
e. Scalability Issues: Traditional blockchain systems, particularly those using PoW, have inherent scalability limitations due to the resource-intensive nature of each transaction and have limited scalability due to the time and resources needed to process each transaction. As the number of transactions grows, the system's ability to handle them without significant delays or increased costs becomes strained.
f. Environmental Concerns: The environmental impact of high resource consumption, especially in PoW, is a growing concern. The massive energy requirements contribute to a larger carbon footprint, prompting a search for more eco-friendly alternatives. The sustainability of these systems is a growing concern, especially in light of global efforts to reduce carbon emissions.
g. Trade-off Between Security and Efficiency: There is often a trade-off between ensuring the security and decentralization of blockchain networks and improving their efficiency. Enhancing transaction speed or reducing resource consumption might impact the network's security or its decentralized nature. In other words, efforts to enhance the efficiency of blockchain networks can sometimes pose risks to their security and decentralized nature. This trade-off is a critical challenge in designing more efficient systems without compromising on the foundational principles of blockchain technology.

These challenges collectively underscore the necessity for innovative solutions that can improve transaction processing efficiency while preserving the essential attributes of blockchain networks such as security, decentralization, and environmental sustainability.

### SUMMARY OF THE INVENTION

In accordance with one or more arrangements of the non-limiting sample disclosures contained herein, solutions are provided to address one or more of the above issues and problems in blockchain processing by, inter alia, optimizing the processing of cryptocurrency transactions, particularly smaller ones, thereby increasing the Transactions Per Second (TPS) rate in Crypto Mining and Minting. Cryptocurrency transactions are streamlined by combining active metadata and reinforcement learning. Users initiate transactions that enter a queue with details like UTXO, sender, and receiver. Active metadata processes and assigns these to nodes. This metadata, including transaction specifics, is fed to the reinforcement learning system. Block creators inform this system of their block size capacity, enabling dynamic adjustment based on transaction sizes. Once processed, transactions are added to blocks and removed from the queue. After validation, the reinforcement learning module awards TPS rewards to the block creator, incentivizing efficient processing.

In some arrangements, this can include one or more of:
a. Transaction Initiation and Queueing: Users initiate a cryptocurrency transaction which enters a Transaction Queue. This queue holds key details such as the Unspent Transaction Outputs (UTXO), as well as the sender and receiver information.
b. Role of Active Metadata: The transaction details are passed to Active Metadata, which processes this information and assigns the transactions to specific nodes for processing. It ensures that the transactions are efficiently distributed within the network.
c. Integration with Reinforcement Learning: Active Metadata communicates the transaction details, including Meta hash, UTXO, sender, and receiver information, to the Reinforcement Learning system.
d. Dynamic Block Sizing: The block creator informs the Reinforcement Learning system about the available block size. The Reinforcement Learning system then issues commands to adjust the block size based on the size of the transactions awaiting processing.
e. Transaction Addition and Notification: After adjusting the block size, the block creator adds the transaction to the block and notifies the Transaction Queue to remove it from the queue.
f. Validation and Rewards: Once the transactions in a block are validated, this information is relayed back to the Reinforcement Learning module. Successful transaction processing leads to claiming TPS as a reward, which is then distributed to the block creator.

In some arrangements, this can include one or more of:
a. Advanced Queue Management: When users initiate transactions, these are queued with detailed information like UTXO, sender, and receiver. This queue acts as a preliminary sorting ground.
b. Active Metadata Processing: The Active Metadata system processes transaction details from the queue, assigning them to appropriate nodes. This ensures efficient distribution and readiness for processing.
c. Communication with Reinforcement Learning: Active Metadata relays detailed transaction data, including metadata, to the Reinforcement Learning system. This system is integral in dynamically managing the process.
d. Reinforcement Learning for Dynamic Adaptation: The block creator informs the Reinforcement Learning system of block size capacity. The system then adapts block sizes in real-time to fit the transaction sizes, optimizing space and processing power.
e. Efficient Transaction Processing: Post size adjustment, transactions are added to blocks. The Transaction Queue is updated on completion, ensuring a streamlined process.
f. Validation and Incentivization: After block validation, the Reinforcement Learning module is updated. Successful processing yields TPS rewards, incentivizing efficient transaction handling.

This approach aims to streamline transaction processing, especially for smaller transactions, by dynamically adjusting block sizes and using AI-driven methods to distribute and process transactions more effectively. This provides higher efficiency, improves overall network performance, and yields more equitable transaction processing in blockchain networks.

Exemplary unique aspects of the inventions disclosed herein include:
a. Transaction Queue: The Transaction Queue acts as a holding area for cryptocurrency transactions initiated by users. Each transaction in the queue contains detailed information such as Unspent Transaction Outputs (UTXO), the sender, and the receiver. This comprehensive data about each transaction is critical for the subsequent stages of processing. The Transaction Queue not only stores these details but also serves as the first point of contact in the processing pipeline, ensuring that all necessary transaction information is captured and ready for further analysis and processing by systems like Active Metadata. This structured approach to handling transactions facilitates efficient and organized processing within the blockchain network.
b. Active Metadata: Active Metadata in this context functions as an advanced data processing layer within the cryptocurrency transaction system. It receives transaction details from the Transaction Queue, including UTXO, sender, receiver, asset value, and transaction size. Utilizing this information, Active Metadata prioritizes transactions for processing by block creators. This prioritization can be based on various criteria, such as transaction size, value, and urgency, ensuring a more efficient and orderly processing of transactions within the blockchain network. Active Metadata plays a crucial role in streamlining the transaction workflow and improving overall transaction processing efficiency.
c. Reinforcement learning: As referenced herein, Reinforcement Learning (RL) is utilized to enhance the efficiency of blockchain transaction processing. RL receives detailed transaction data from Active Metadata and block size information from the block creator. Using this data, RL applies algorithms to dynamically adjust the block size in response to the current transaction load. This adaptive approach allows the blockchain to process varying transaction sizes more efficiently, particularly smaller ones. RL plays a crucial role in optimizing blockchain resource utilization and improving the overall throughput of the system.
d. Reward: The reward mechanism in this system incentivizes block creators for their efficiency in processing transactions. Once transactions are added to a block and successfully validated, the block creator becomes eligible to claim a reward based on the Transactions Per Second (TPS) they have achieved. This reward system is designed to motivate block creators to optimize their processing speed and efficiency, ultimately leading to a more responsive and effective blockchain network. The TPS-based reward serves as a key driver for improving transaction throughput and overall network performance.
e. Block Size Availability: This refers to the information about the available size of a block in the blockchain, as provided by the block creator. This data is crucial for the Reinforcement Learning system to effectively adjust block sizes in accordance with the transaction sizes it needs to process. By knowing the block size capacity, the system can optimize how transactions are grouped and processed, enhancing overall efficiency, and allowing for better management of the blockchain's resources. This component is integral to maintaining a balance between transaction throughput and the limitations of block size.
f. Command Object Generation: This is a pivotal step in this cryptocurrency transaction optimization system. It refers to the process of creating command objects that facilitate the dynamic adjustment of block sizes based on the sizes of the transactions to be processed. More specifically, it can be understood in the following context:
   i. Transaction Size Assessment: Before generating command objects, the system assesses the size of each incoming transaction. This assessment involves evaluating various aspects of the transaction, such as the amount being transferred, the number of inputs and outputs, and any additional data included with the transaction.
   ii. Block Size Compatibility: The system then compares the size of the incoming transactions with the available block size, as communicated by the block creator. It checks whether the transactions can comfortably fit within the current block size capacity.
   iii. Command Object Creation: If it's determined that the block size needs to be adjusted to accommodate the incoming transactions efficiently, command objects are generated. These command objects contain instructions for modifying the block size, either by expanding it to accommodate larger transactions or shrinking it to conserve space.
   iv. Real-Time Adaptation: The generated command objects are sent to the relevant blocks in real-time. This allows for dynamic adjustments of block sizes, ensuring that each block can accommodate its assigned transactions optimally.
   v. Efficient Transaction Processing: With the block sizes adapted to the transaction sizes, the transactions are seamlessly added to the blocks. This process ensures efficient utilization of block space, minimizing wasted capacity and processing resources.
By implementing Command Object Generation, the system can effectively balance the varying sizes of cryptocurrency transactions with the available block sizes. This adaptability promotes optimal resource usage, enhances transaction processing speed, and contributes to the overall efficiency and scalability of the blockchain network.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, a blockchain transaction processing system can comprise one or more of:
a. a Transaction Queue configured to receive, store, and prioritize cryptocurrency transactions from users, each transaction distinctly represented as an Unspent Transaction Output (UTXO) with comprehensive sender and receiver information, and transaction value;
b. an Active Metadata module, operatively connected to the Transaction Queue, configured to analyze and process intricate details of each transaction, including calculating the precise real value and size of each transaction, and continuously assessing available block size within the blockchain network for optimal transaction accommodation;
c. a Reinforcement Learning module, communicatively linked to the Active Metadata module, configured to receive detailed transaction data and block size information, and to apply advanced machine learning algorithms for dynamic adjustment of block sizes based on the aggregated size of transactions awaiting processing, thereby enhancing processing efficiency;
d. a Block Creator interface, operatively connected to the Reinforcement Learning module, configured to receive a stream of optimized transactions for inclusion in blockchain blocks, and to provide real-time block size information to the Reinforcement Learning module for ongoing transaction optimization;
e. a comprehensive transaction merging mechanism for aggregating multiple smaller transactions into a singular larger transaction package, represented by a unique meta hash, wherein the meta hash is intricately linked to the Active Metadata and encapsulates exhaustive information about all individual transactions included within the merged package; a sophisticated command issuance system within the Reinforcement Learning module, configured to precisely instruct the Block Creator to integrate the merged transaction into a designated blockchain block, and to adeptly manage the block space by intelligently freeing up any superfluous space, facilitating the inclusion of additional transactions;
f. a robust validation module, integral to the system, for performing thorough validation of the complete blockchain block containing the merged transaction, employing a complex consensus mechanism within the blockchain network to ensure the utmost legitimacy, accuracy, and integrity of the transactions; and/or
g. an advanced segregation and completion mechanism, activated post-validation by the active metadata module, designed to meticulously segregate individual transactions from the merged package, ensuring each transaction, represented by its respective UTXO, is accurately and securely assigned to the intended counterpart's wallet, thereby completing the transaction cycle.

In some arrangements, the Transaction Queue further includes a prioritization algorithm configured to prioritize transactions based on predefined criteria, such as transaction value, urgency, or user status.

In some arrangements, the Active Metadata module is further configured to dynamically update its processing based on real-time changes in the blockchain network, such as fluctuations in block size availability or network congestion.

In some arrangements, the Reinforcement Learning module incorporates adaptive learning algorithms capable of evolving strategies for block size adjustment and transaction optimization based on historical blockchain network performance data.

In some arrangements, the Block Creator interface includes a feedback mechanism to the Reinforcement Learning module, providing continuous updates on block creation efficiency and transaction inclusion success rates.

In some arrangements, the transaction merging mechanism is configured to selectively merge transactions based on criteria like transaction size, cost, and processing urgency, to create an optimized meta hash.

In some arrangements, the command issuance system within the Reinforcement Learning module includes an automated decision-making process for block space management, considering factors like current network load and anticipated transaction volume.

In some arrangements, the validation module includes an enhanced security protocol to detect and prevent fraudulent transactions during the validation process.

In some arrangements, the segregation and completion mechanism is further enhanced to perform real-time audit checks to ensure accuracy in the distribution of UTXOs to the respective counterparts' wallets.

In some arrangements, the system is configured to operate in various blockchain environments, including both Proof of Work and Proof of Stake systems, demonstrating flexibility and adaptability in different blockchain network architectures.

In some arrangements, a method for optimizing blockchain transaction processing can comprising one or more steps such as, for example:
a. receiving individual cryptocurrency transactions from users and cataloging them in a Transaction Queue, where each transaction is distinctly represented as an Unspent Transaction Output (UTXO) with comprehensive details including sender and receiver identities, and transaction amount;
b. engaging an Active Metadata module to thoroughly analyze transaction specifics, including the intricate calculation of the actual transaction value and data size, and continuously assessing the real-time block size availability within the blockchain network for optimal space allocation;
c. utilizing a sophisticated Reinforcement Learning module that applies complex, adaptive algorithms to dynamically adjust block sizes, tailored specifically to the collective size of the pending transactions, thereby optimizing the transaction processing efficiency;
d. implementing a communication protocol between the Reinforcement Learning module and a Block Creator, designed to relay optimized transaction data for effective inclusion in blockchain blocks, ensuring maximal block utilization;
e. executing a transaction merging mechanism to aggregate numerous smaller transactions into a singular, larger transaction package, uniquely represented by a detailed meta hash. This meta hash encapsulates exhaustive information about all individual transactions it represents, maintaining transaction integrity while optimizing processing;
f. directing the Block Creator to incorporate the merged transaction into the blockchain block, with an integrated system for intelligent block space management, ensuring additional transaction accommodation by freeing up unnecessary space;
g. conducting a comprehensive validation of the complete blockchain block containing the merged transaction, employing a robust consensus mechanism within the blockchain network to guarantee the legitimacy, accuracy, and security of the transactions; and/or
h. implementing a segregation and completion protocol in the Active Metadata module, post-block validation, meticulously designed to accurately segregate individual transactions from the merged package. Each transaction, still represented by its respective UTXO, is securely and precisely assigned to the intended recipient's wallet, finalizing the transaction cycle with integrity and accuracy.

In some arrangements, the step of receiving and storing transactions includes prioritizing the transactions in the Transaction Queue based on predefined criteria, including but not limited to transaction value, urgency, or user status.

In some arrangements, the method may further comprise the step of dynamically updating the transaction processing strategy in the Active Metadata module in response to fluctuations in blockchain network conditions, such as block size availability or network congestion.

In some arrangements, the Reinforcement Learning module adapts its block size adjustment strategies based on historical data and performance metrics of the blockchain network.

In some arrangements, the method may include a feedback mechanism from the Block Creator to the Reinforcement Learning module, providing insights into the efficiency and success rates of block creation and transaction inclusion.

In some arrangements, the step of merging transactions into a larger package includes selectively combining transactions based on specific characteristics, such as transaction size, associated costs, and processing priority.

In some arrangements, the method may further comprise the step of an automated decision-making process within the Reinforcement Learning module for optimally managing block space based on current network load and anticipated future transaction volumes.

In some arrangements, the method may further comprise the step of including an enhanced security protocol within the validation module for detecting and mitigating fraudulent transactions during the validation phase.

In some arrangements, the step of segregating and completing transactions includes performing real-time audit checks to ensure accuracy in the distribution of UTXOs to the intended recipients' wallets.

In some arrangements, one or more various steps or processes disclosed herein can be implemented in whole or in part as computer-executable instructions (or as computer modules or in other computer constructs) stored on computer-readable media. Functionality and steps can be performed on a machine or distributed across a plurality of machines that are in communication with one another.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 depicts a sample functional overview diagram showing sample interactions, interfaces, steps, functions, and components of active metadata and reinforcement learning in accordance with one or more aspects of this disclosure as they relate to improving transactions per second in cryptocurrency mining and minting.

FIG. 2 depicts another sample functional flow diagram showing sample interactions, interfaces, steps, functions, and components of active metadata and reinforcement learning in accordance with one or more aspects of this disclosure as they relate to improving transactions per second in cryptocurrency mining and minting.

FIGS. 3A and 3B depict sample transaction metadata and active metadata that can be utilized by reinforcement learning in accordance with one or more aspects of this disclosure in order to speed up transaction approval and increase transactions per second.

FIG. 4 depicts a sample process with exemplary interactions, interfaces, steps, functions, and components of active metadata and reinforcement learning in accordance with one or more aspects of this disclosure as they relate to improving transactions per second in cryptocurrency mining and minting.

### DETAILED DESCRIPTION

In the following description of the various embodiments to accomplish the foregoing, reference is made to the drawings, which form a part hereof, and in which is shown by way of illustration, various embodiments in which the disclosure may be practiced. It is to be understood that other embodiments may be utilized, and structural and functional modifications may be made. It is noted that various connections between elements are discussed in the following description. It is noted that these connections are general and, unless specified otherwise, may be direct or indirect, wired, or wireless, and that the specification is not intended to be limiting in this respect.

As used throughout this disclosure, any number of computers, machines, or the like (referenced interchangeably herein depending on context) can include one or more general-purpose, customized, configured, special-purpose, virtual, physical, and/or network-accessible devices as well as all hardware/software/components contained therein or used therewith as would be understood by a skilled artisan, and may have one or more application specific integrated circuits (ASICs), microprocessors, cores, executors etc. for executing, accessing, controlling, implementing etc. various software, computer-executable instructions, data, modules, processes, routines, or the like as explained below. References herein are not considered limiting or exclusive to any type(s) of electrical device(s), or component(s), or the like, and are to be interpreted broadly as understood by persons of skill in the art. Various specific or general computer/software components, machines, or the like are not depicted in the interest of brevity or discussed herein in detail because they would be known and understood by ordinary artisans.

Software, computer-executable instructions, data, modules, processes, routines, or the like can be on tangible computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like including memory and other components thereof. Some or all the foregoing may additionally and/or alternatively be stored similarly and/or in a distributed manner in the network accessible storage/distributed data/datastores/databases/big data/blockchains/distributed ledger blockchains etc.

As used throughout this disclosure, computer “networks,” topologies, or the like can include one or more local area networks (LANs), wide area networks (WANs), the Internet, clouds, wired networks, wireless networks, digital subscriber line (DSL) networks, frame relay networks, asynchronous transfer mode (ATM) networks, virtual private networks (VPN), or any direct or indirect combinations of the same. They may also have separate interfaces for internal network communications, external network communications, and management communications. Virtual IP addresses (VIPs) may be coupled to each if desired. Networks also include associated equipment and components such as access points, adapters, buses, ethernet adaptors (physical and wireless), firewalls, hubs, modems, routers, and/or switches located inside the network, on its periphery, and/or elsewhere, and software, computer-executable instructions, data, modules, processes, routines, or the like executing on the foregoing. Network(s) may utilize any transport that supports HTTPS or any other type of suitable communication, transmission, and/or other packet-based protocol.

Generative Artificial Intelligence (AI) refers to AI techniques that learn a representation of training data and use it to generate new content that is similar to or inspired by existing data. Generated content may include human-like outputs such as natural language text, source code, images/videos, and audio samples. Generative AI solutions typically leverage open-source or vendor sourced (proprietary) models, and can be provisioned in a variety of ways, including, but not limited to, Application Program Interfaces (APIs), websites, search engines, and chatbots. Most often, Generative AI solutions are powered by Large Language Models (LLMs) which were pre-trained on large datasets using deep learning with over 500 million parameters and reinforcement learning methods. Any usage of Generative AI and LLMs is preferably governed by an Enterprise AI Policy and an Enterprise Model Risk Policy.

Generative artificial intelligence models have been evolving rapidly, with various organizations developing their own versions. Sample generative AI models that can be used in accordance with various aspects of this disclosure include, but are not limited to:
a. OpenAI GPT Models:
   i. GPT-3: Known for its ability to generate human-like text, it's widely used in applications ranging from writing assistance to conversation.
   ii. GPT-4: An advanced version of the GPT series with improved language understanding and generation capabilities.
b. Meta (formerly Facebook) AI Models-Meta LLAMA (Language Model Meta AI): Designed to understand and generate human language, with a focus on diverse applications and efficiency.
c. Google AI Models:
   i. BERT (Bidirectional Encoder Representations from Transformers): Primarily used for understanding the context of words in search queries.
   ii. T5 (Text-to-Text Transfer Transformer): A versatile model that converts all language problems into a text-to-text format.
d. DeepMind AI Models:
   i. GPT-3.5: A model similar to GPT-3, but with further refinements and improvements.
   ii. AlphaFold: A specialized model for predicting protein structures, significant in the field of biology and medicine.
e. NVIDIA AI Models-Megatron: A large, powerful transformer model designed for natural language processing tasks.
f. IBM AI Models-Watson: Known for its application in various fields, including healthcare and business, for processing and analyzing large amounts of natural language data.
g. XLNet: An extension of the Transformer model, outperforming BERT in several benchmarks.
h. GROVER: Designed for detecting and generating news articles, useful in understanding media-related content.

These models represent a range of applications and capabilities in the field of generative AI. One or more of the foregoing may be used herein as desired.

For reference, sample generative AI/LLM use cases include generating human-like text, searching and retrieving information, summarizing text, performing classification, understanding natural language, answering questions, analyzing sentiment, filtering content, translating language, assisting with computer code, generating content for creative applications and more, etc.

As detailed herein, the disclosed inventions focus on enhancing transaction processing speed (TPS) in cryptocurrency mining and minting by implementing active metadata and reinforcement learning. The problem it addresses is the inefficiency in Proof of Work and Proof of Minting systems, where creating blocks and approving transactions can be time-consuming and resource intensive. The inventions provide technical solutions where transactions are settled in a Transaction Queue, processed by Active Metadata, and then optimized in size by Reinforcement Learning to fit within block space availability. The systems and methods disclosed herein prioritize and speed up the approval of smaller transactions, enhancing overall TPS, and rewarding block creators based on TPS improvements. They focus on improving the efficiency of transaction processing in blockchain networks, particularly in Proof of Work (PoW) and Proof of Minting (POM) systems. The solutions presented herein address critical issues like slow transaction processing, network congestion, high resource consumption, inequitable e transaction prioritization, scalability limitations, environmental concerns, and the trade-off between security and efficiency.

The innovations combine active metadata and reinforcement learning to optimize cryptocurrency transaction processing, thereby enhancing the Transactions Per Second (TPS) rate in crypto mining and minting. Key aspects of the invention include:
a. Transaction Initiation and Queueing: Users initiate cryptocurrency transactions, which enter a Transaction Queue with detailed information like Unspent Transaction Outputs (UTXO), sender, and receiver.
b. Active Metadata Role: This system processes transaction details and assigns them to specific nodes for efficient distribution within the network.
c. Integration with Reinforcement Learning: Active Metadata communicates detailed transaction data, including Meta hash, UTXO, sender, and receiver information, to the Reinforcement Learning system.
d. Dynamic Block Sizing: Block creators inform the Reinforcement Learning system about their available block size, allowing the system to dynamically adjust block sizes based on transaction sizes.
e. Transaction Processing and Notification: After block size adjustment, transactions are added to blocks and removed from the queue.
f. Validation and Rewards: Post-validation, the Reinforcement Learning module awards TPS rewards to the block creator, incentivizing efficient transaction processing.

The approaches streamline transaction processing, particularly for smaller transactions, by dynamically adjusting block sizes and utilizing AI-driven methods for efficient transaction distribution and processing. They improve overall network performance and facilitate more equitable transaction processing in blockchain networks.

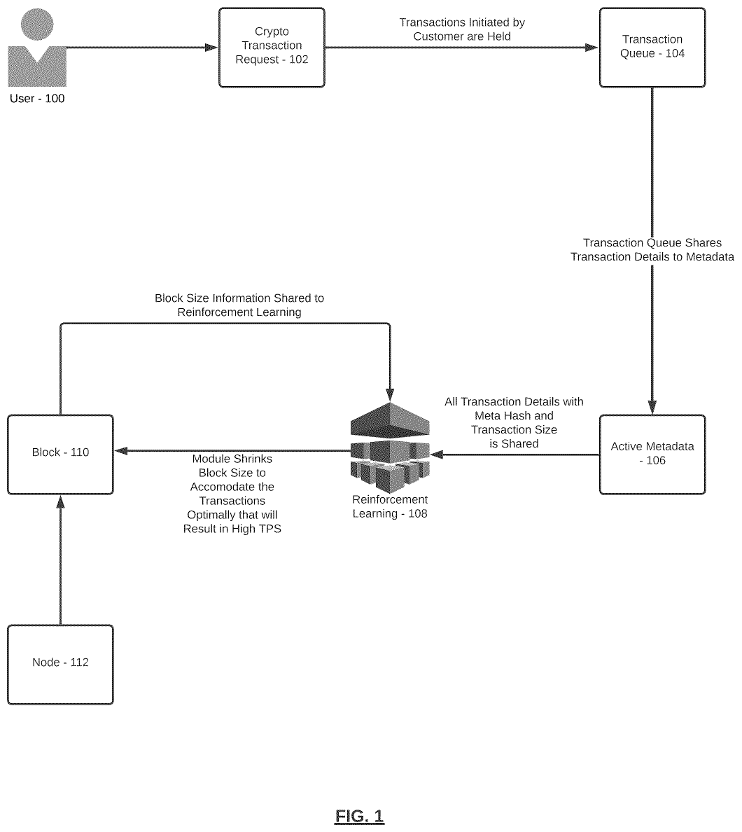

By way of non-limiting reference, FIG. 1 depicts a sample functional overview diagram showing sample interactions, interfaces, steps, functions, and components of active metadata and reinforcement learning in accordance with one or more aspects of this disclosure as they relate to improving transactions per second in crypto mining and minting.

FIG. 1 illustrates the flow of a cryptocurrency transaction from initiation by the user to the completion of the process. It shows how transactions are held in a queue, details are shared with active metadata, and how the block size is adjusted by the reinforcement learning module to accommodate transactions optimally, resulting in a high TPS.

FIG. 1 presents a detailed flowchart of the cryptocurrency transaction process in the inventions. Here's an expanded description integrating the reference numbers identified in the figure:
a. User (100): The process starts with a user initiating a cryptocurrency transaction.
b. Crypto Transaction Request (102): The user's request for a transaction, which could be sending or receiving cryptocurrency.
c. Transaction Queue (104): Transactions initiated by customers are held in this queue. This includes the waiting period before processing.
d. Active Metadata (106): All transaction details, including meta hash and transaction size, are shared with this active metadata system. It plays a crucial role in processing transaction details and preparing them for the next stages.
e. Reinforcement Learning (108): This module receives information about the block size and the transaction details from the active metadata. It is responsible for learning and adapting to optimize transaction processing and block size adjustment.
f. Block (110): The block in the blockchain where transactions are eventually recorded. This module can shrink the block size to accommodate transactions optimally, resulting in a high TPS.
g. Node (112): The node in the blockchain network which plays a role in validating and processing the transactions.

This flowchart illustrates the complete journey of a cryptocurrency transaction from the user's initiation to its eventual processing and recording in a blockchain block. It emphasizes the roles of active metadata and reinforcement learning in optimizing the transaction process for improved efficiency and higher TPS.

Hence, FIG. 1 is illustrating a novel approach to improve the efficiency of transaction processing in cryptocurrency networks. This approach directly addresses the challenge that smaller transactions often face in terms of processing speed and priority.

The process begins with customers initiating crypto transactions, which enter a transaction queue. In traditional systems, smaller transactions are often deprioritized by block creators due to their lower processing costs and similar block space consumption as larger transactions. This leads to inefficiencies, as small transactions either incur higher costs to expedite processing or face significant delays.

To counter this, the system utilizes active metadata to gather and analyze transaction details, including the transaction value and available block space. This metadata then helps in aggregating multiple smaller transactions into one large transaction. After processing, these transactions are segregated and sent to their respective recipients.

Reinforcement learning plays a crucial role here. It incentivizes block creators to process these aggregated transactions quickly by rewarding them based on the TPS rate they achieve. This ensures that smaller transactions are processed more efficiently and equitably.

In the context of FIG. 1, this sample process is visually represented. The transaction queue holds individual transactions, which are then combined by active metadata. The reinforcement learning system optimizes this combined transaction for the block creator, who then processes it efficiently, resulting in a higher TPS rate. This innovative approach not only speeds up transaction processing but also aligns the interests of block creators with the overall efficiency of the blockchain network, creating a win-win situation for all parties involved.

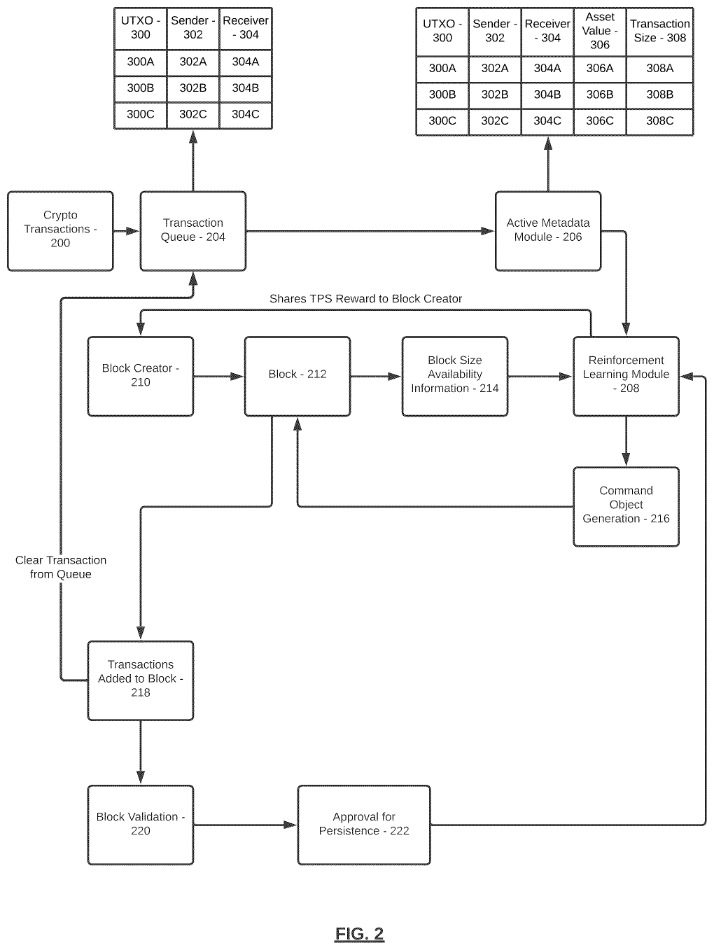

By way of non-limiting reference, FIG. 2 depicts another sample functional flow diagram showing sample interactions, interfaces, steps, functions, and components of active metadata and reinforcement learning in accordance with one or more aspects of this disclosure as they relate to improving transactions per second in crypto mining and minting.

FIG. 2 expands on the transaction details and their flow through the system. It shows various components like UTXO, sender/receiver details, asset value, and transaction size. The process includes the transaction queue, active metadata module, block creator, and reinforcement learning module, highlighting how each component contributes to the transaction processing and TPS optimization.

FIG. 2 provides a more detailed schematic of the transaction flow for the systems and methods disclosed herein, incorporating various components and their interactions. The reference numbers in FIG. 2 help in identifying and understanding each part of the process:
a. Transaction Queue (200): This is where user-initiated cryptocurrency transactions are initially held. It represents the collection of all pending transactions waiting to be processed.
b. Active Metadata (202): Active Metadata is a critical component that processes the detailed information of each transaction. This includes the meta hash, Unspent Transaction Outputs (UTXO), and details of the sender and receiver.
c. Block Creator (204): The Block Creator is responsible for creating new blocks in the blockchain. This component receives optimized transaction information from the Active Metadata for block inclusion.
d. Reinforcement Learning (206): This module receives input regarding the available block size from the Block Creator and the transaction details from the Active Metadata. Its role is to apply learning algorithms to optimize transaction inclusion in the blocks, enhancing the overall efficiency of the process.
e. Processed Transactions (208): These are the transactions that have been successfully processed, optimized, and are ready to be added to the blockchain.
f. Transaction Details (210): This segment focuses on the individual components of each transaction, including UTXO, sender, receiver, asset value, and transaction size.
g. Optimized Transactions (212): Transactions that have been adjusted and optimized for inclusion in the blockchain. This optimization is a result of the interplay between Active Metadata and Reinforcement Learning, focusing on efficient utilization of block space.
h. Block Size Information (214): Information pertaining to the current available size of the block, which is crucial for the Reinforcement Learning module to optimize transaction processing.

The figure highlights the interconnectedness of these components in the system, demonstrating how they work together to improve transaction processing efficiency in cryptocurrency networks. The focus on active metadata and reinforcement learning as key drivers of efficiency is evident, illustrating a sophisticated approach to managing blockchain transactions.

Expanding on the process illustrated in FIG. 2, a detailed technical solution is provided as an example for optimizing cryptocurrency transactions. This solution primarily focuses on efficient transaction processing, especially for smaller transactions, which are often deprioritized in the current crypto systems.

Regarding Transaction Initiation and Queueing, when a user initiates a crypto transaction, it is represented as UTXO (Unspent Transaction Output) with essential details like sender and receiver information. This transaction is placed in a queue. This phase is crucial in the process of handling cryptocurrency transactions. When a user initiates a transaction in the blockchain network, it is encapsulated as an Unspent Transaction Output (UTXO). The UTXO represents the specifics of the transaction, including essential details like the sender's and receiver's information. This is a fundamental concept in blockchain technology, where each transaction output becomes an input for future transactions. Once this transaction is initiated, it doesn't immediately get processed but is placed in a transaction queue. This queue acts as a holding area for all transactions before they are processed further. The transaction queue plays a critical role in managing the flow and order of transactions, ensuring they are processed in an organized manner.

For Active Metadata Processing, Active metadata calculates the real value and size of each transaction. It also checks the available block size to determine how many transactions can be accommodated. Active Metadata Processing is a sophisticated component of the transaction management system in blockchain technology. In this phase, active metadata plays a vital role in analyzing each transaction's specifics, including its real value and the data size it occupies. This process involves deep analysis to accurately determine the actual space required by a transaction in a blockchain block, rather than using a standard size. Additionally, active metadata assesses the current available block size within the blockchain. This assessment is crucial to efficiently allocate space in a block, determining how many transactions can be accommodated in the given block size. By optimizing the use of block space, this process helps in enhancing the overall efficiency of the blockchain network, ensuring that each block is utilized to its maximum potential.

For Merging Transactions and Meta Hash Creation, multiple smaller transactions are merged to form a larger transaction package, which is represented by a single meta hash. This meta hash, linked to the active metadata, contains information about all the individual transactions it represents. The “Merging Transactions and Meta Hash Creation” phase of the process involves combining several smaller cryptocurrency transactions into a single, larger transaction package. This is done to optimize the processing efficiency and to address the preference of block creators for larger transactions. The combined package is represented by a single meta hash. This meta hash acts as a unique identifier for the collective transaction. It is linked to active metadata, which holds detailed information about all the individual transactions included in the merged package. This linking is crucial as it maintains the traceability and distinctness of each transaction within the larger grouped transaction, ensuring that once the combined transaction is processed, each component can be accurately segregated and directed to the correct recipient.

Regarding Reinforcement Learning and Command Issuance, the reinforcement learning module issues commands to the block creator, instructing them to add the merged transaction to the block. It also has the capability to free up unused block space, making room for more transactions. In the “Reinforcement Learning and Command Issuance” phase, the reinforcement learning module plays a pivotal role. It issues specific commands to the block creator, directing them to incorporate the merged transaction into the upcoming block. This step is critical in ensuring that the combined transaction, represented by the meta hash, is efficiently processed in the blockchain. Furthermore, the module possesses the capability to dynamically manage block space. It can free up any unused space within the block, thereby optimizing the block's capacity. This space optimization not only allows for the inclusion of more transactions but also enhances the overall efficiency of transaction processing within the blockchain network. The reinforcement learning module, therefore, serves as a crucial bridge between the transaction merging process and the final block creation, ensuring a smooth, efficient, and optimized transaction flow.

For Block Processing and Validation, the full block is then sent for validation. The consensus mechanism in the blockchain network ensures the legitimacy and accuracy of the transactions. In the “Block Processing and Validation” stage, the completed block, containing the merged transactions, is forwarded for validation. This is a critical phase in blockchain operations, where the consensus mechanism comes into play. The consensus mechanism is a fundamental aspect of blockchain technology, responsible for ensuring the legitimacy and accuracy of transactions within a block. It involves various nodes in the blockchain network agreeing on the validity of the transactions, thereby maintaining the integrity and trustworthiness of the blockchain. This validation process is essential for confirming that all transactions in the block are legitimate and correctly processed before being permanently added to the blockchain ledger.

Regarding Segregation and Completion of Transactions, after the block is validated, the active metadata module segregates the individual transactions from the merged package. Each transaction, represented by the UTXO, is then assigned to the respective counterpart's wallet. The “Segregation and Completion of Transactions” stage involves the active metadata module post-block validation. Once the block containing the merged transactions is validated through the consensus mechanism, the active metadata module undertakes the task of segregating these combined transactions back into their individual components. Each transaction, initially represented as an Unspent Transaction Output (UTXO), is accurately distributed to the respective recipient's wallet. This segregation is essential to ensure that despite the transactions being merged for processing efficiency, each transaction reaches its intended recipient correctly, maintaining the integrity of individual transactional data.

The disclosed systems and processes, through their innovative use of active metadata and reinforcement learning, significantly improve the efficiency of transaction processing, particularly benefiting smaller transactions and enhancing the overall transaction per second (TPS) rate of the blockchain network. It presents a balanced approach that benefits both the block creators and the users initiating transactions.

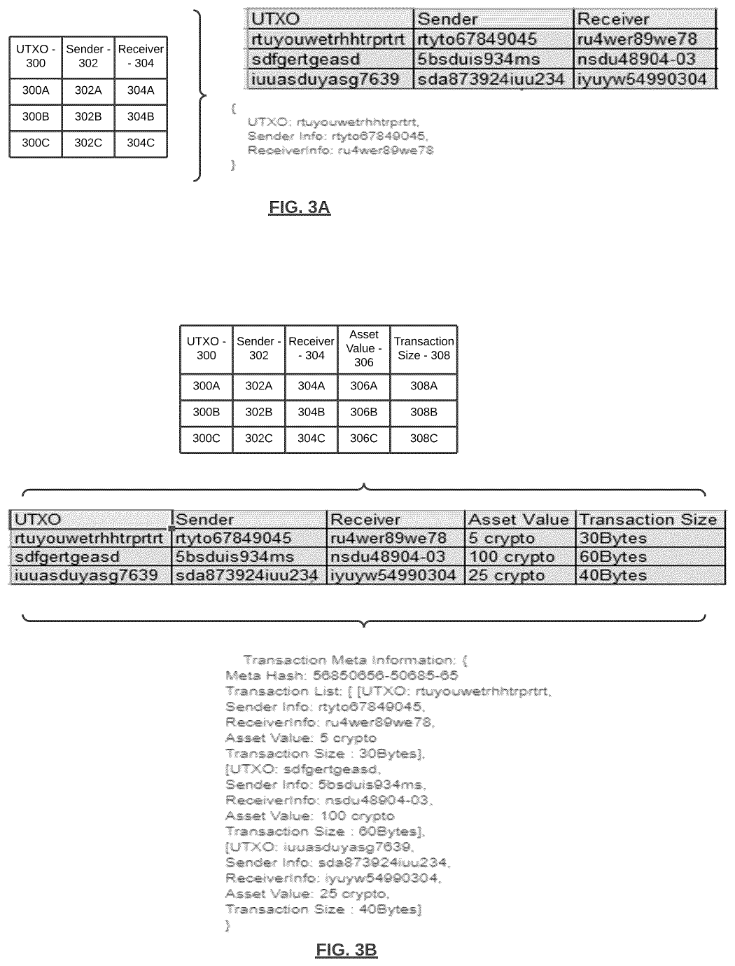

By way of non-limiting reference, FIGS. 3A and 3B depict sample transaction metadata and active metadata that can be utilized by reinforcement learning in accordance with one or more aspects of this disclosure in order to speed up transaction approval and increase transactions per second.

FIGS. 3A and 3B provide a more detailed view of the transaction components (UTXO, sender, receiver, asset value, transaction size) and their interrelations. It demonstrates the complex interplay of these elements in the transaction process.

FIG. 3A provides examples of metadata that includes headers for the UTXO 300, sender 302, and receiver 304 for each transaction. It is depicted in a table format. Rows beneath the header provide metadata samples for the transactions, namely, UTXO examples of 300A-C, senders 302A-C, and receivers 304A-C. A sample code depiction corresponding to the example is provided as well.

FIG. 3B similarly provides examples of active metadata that includes headers for the UTXO 300, sender 302, receiver 304, asset value, and transaction size for each transaction. It is depicted in a table format. Rows beneath the header provide active metadata samples for the transactions, namely, UTXO examples of 300A-C, senders 302A-C, receivers 304A-C, asset values 306A-C, and transaction size 308A-C. A sample code depiction corresponding to the example is provided as well.

These sub-figures collectively illustrate the detailed process of transaction management in your system. They emphasize the critical roles of active metadata and reinforcement learning in streamlining the transaction process, from the initial queueing of transactions to their eventual inclusion in a blockchain block. The focus is on optimizing transaction sizes and structures for efficient processing and block inclusion, highlighting a sophisticated approach to managing blockchain transactions.

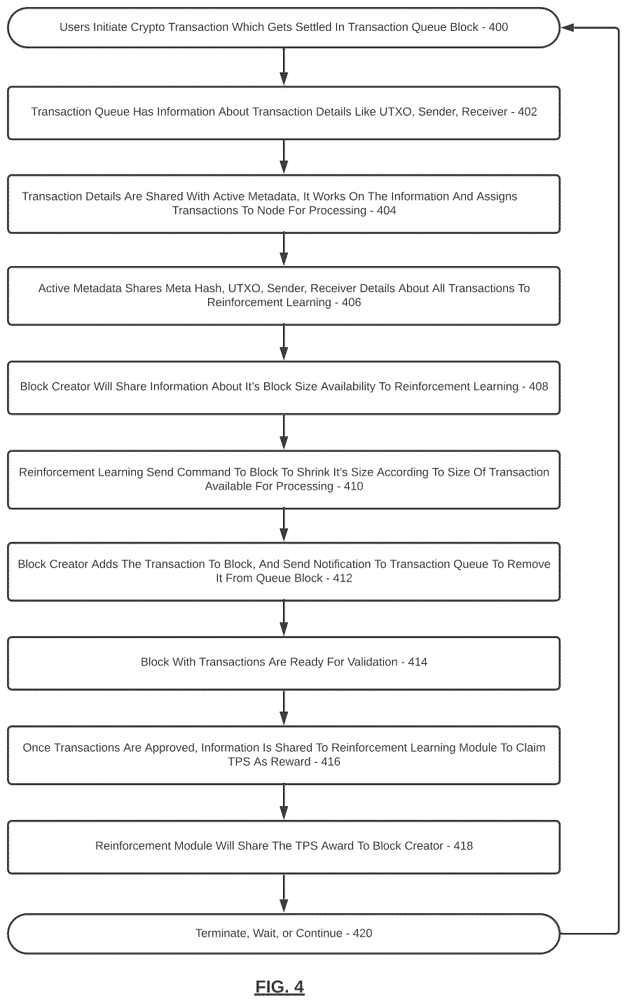

By way of non-limiting reference, FIG. 4 depicts a sample process with exemplary interactions, interfaces, steps, functions, and components of active metadata and reinforcement learning in accordance with one or more aspects of this disclosure as they relate to improving transactions per second in crypto mining and minting.

FIG. 4 illustrates the entire process from user-initiated transactions to the final transaction approval and TPS reward distribution. It details each step, including the roles of the transaction queue, active metadata, block size information sharing, and the reinforcement learning module in processing and optimizing transactions.

Expanding on the description of FIG. 4, this detailed flowchart showcases the systems and processes for handling cryptocurrency transactions from start to finish. Each step, denoted by reference numbers, contributes to a system designed for optimizing transaction processing in blockchain networks. This sample process can be summarized as follows:
a. User (400): This is the starting point of the transaction process. A user, who could be an individual or an entity, initiates a cryptocurrency transaction. This could involve sending or receiving digital currency, or any other operation that requires blockchain recording.
b. Crypto Transaction Request (402): The user's transaction request encapsulates all the necessary information for executing a blockchain transaction. This includes the amount to be transferred, the recipient's address, and any other relevant details.
c. Transaction Queue (404): Upon initiation, the transaction enters the Transaction Queue. This is a waiting area where transactions are collected before they are processed. The queue manages the order and priority of transactions, ensuring they are processed efficiently.
d. Active Metadata (406): Active Metadata plays a pivotal role in processing the transaction. It analyzes and processes all the transaction details, including meta hash and the size of the transaction. This system ensures that all necessary information is accurately captured and prepared for the next stages of processing.
e. Reinforcement Learning (408): This advanced module leverages artificial intelligence to optimize transaction processing. It receives detailed transaction data from the Active Metadata and block size information, applying machine learning algorithms to determine the most efficient way to include transactions in the upcoming block. This optimization is key to enhancing the Transactions Per Second (TPS) rate, a critical metric in blockchain efficiency.
f. Block Creator (410): The Block Creator is tasked with forming new blocks in the blockchain. This component uses the optimized transaction data provided by the Reinforcement Learning module. Efficient block creation is crucial for maintaining the blockchain's integrity and speed.
g. Block (412): This represents the actual blockchain block where the transactions are recorded. The block includes all processed and optimized transactions, ensuring they are permanently recorded in the blockchain ledger.
h. Node (414): Nodes in the blockchain network play a critical role in validating and processing transactions. They ensure the network's security and integrity, verifying transactions and blocks according to the network's protocol.
i. Processed Transactions (416): These are the transactions that have been successfully processed and optimized for inclusion in the blockchain. This step marks the completion of the transaction's journey from initiation to recording.
j. TPS Rewards (418): To incentivize efficiency, the system includes a TPS Rewards mechanism. Block creators who contribute to improving the TPS rate are rewarded, encouraging faster and more efficient transaction processing. This reward system aligns the interests of block creators with the overall efficiency of the blockchain network.

Through this comprehensive process, the systems and processes disclosed herein aim to significantly enhance the transaction processing capabilities of blockchain networks. By integrating advanced technologies like active metadata and reinforcement learning, it addresses key challenges such as scalability, efficiency, and speed, making blockchain transactions more accessible and practical for a wide range of applications.

The figures referenced herein, and the above exemplary discussions, collectively contribute to a comprehensive understanding of the systems and processes by which the disclosed innovations optimize transaction processing in blockchain networks, particularly focusing on improving efficiency, scalability, and the equitable processing of transactions.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A blockchain transaction processing system comprising:
a Transaction Queue configured to receive, store, and prioritize cryptocurrency transactions from users, each transaction distinctly represented as an Unspent Transaction Output (UTXO) with comprehensive sender and receiver information, and transaction value;
an Active Metadata module, operatively connected to the Transaction Queue, configured to analyze and process intricate details of each transaction, including calculating a precise real value and size of each transaction, and continuously assessing available block size within a blockchain network for optimal transaction accommodation;
a Reinforcement Learning module, communicatively linked to the Active Metadata module, configured to receive detailed transaction data and block size information, and to apply advanced machine learning algorithms for dynamic adjustment of block sizes based on an aggregated size of transactions awaiting processing, thereby enhancing processing efficiency;
a Block Creator interface, operatively connected to the Reinforcement Learning module, configured to receive a stream of optimized transactions for inclusion in blockchain blocks, and to provide real-time block size information to the Reinforcement Learning module for ongoing transaction optimization;
a comprehensive transaction merging mechanism for aggregating multiple smaller transactions into a singular larger transaction package, represented by a unique meta hash, wherein the meta hash is intricately linked to the Active Metadata and encapsulates exhaustive information about all individual transactions included within a merged package;
a sophisticated command issuance system within the Reinforcement Learning module, configured to precisely instruct the Block Creator to integrate the merged transaction into a designated blockchain block, and to adeptly manage a block space by intelligently freeing up any superfluous space, facilitating the inclusion of additional transactions;
a robust validation module, integral to the system, for performing thorough validation of a complete blockchain block containing the merged transaction, employing a complex consensus mechanism within the blockchain network to ensure legitimacy, accuracy, and integrity of the transactions; and
an advanced segregation and completion mechanism, activated post-validation by the active metadata module, designed to meticulously segregate individual transactions from the merged package, ensuring each transaction, represented by its respective UTXO, is accurately and securely assigned to an intended counterpart's wallet, thereby completing a transaction cycle.

2. The system of claim 1, wherein the Transaction Queue further includes a prioritization algorithm configured to prioritize transactions based on predefined criteria, such as transaction value, urgency, or user status.

3. The system of claim 2, wherein the Active Metadata module is further configured to dynamically update its processing based on real-time changes in the blockchain network, such as fluctuations in block size availability or network congestion.

4. The system of claim 3, wherein the Reinforcement Learning module incorporates adaptive learning algorithms capable of evolving strategies for block size adjustment and transaction optimization based on historical blockchain network performance data.

5. The system of claim 4, wherein the Block Creator interface includes a feedback mechanism to the Reinforcement Learning module, providing continuous updates on block creation efficiency and transaction inclusion success rates.

6. The system of claim 5, wherein the transaction merging mechanism is configured to selectively merge transactions based on criteria like transaction size, cost, and processing urgency, to create an optimized meta hash.

7. The system of claim 6, wherein the command issuance system within the Reinforcement Learning module includes an automated decision-making process for block space management, considering factors like current network load and anticipated transaction volume.

8. The system of claim 7, wherein the validation module includes an enhanced security protocol to detect and prevent fraudulent transactions during a validation process.

9. The system of claim 8, wherein the segregation and completion mechanism is further enhanced to perform real-time audit checks to ensure accuracy in a distribution of UTXOs to a respective counterparts' wallets.

10. The system of claim 9, wherein the system is configured to operate in various blockchain environments, including both Proof of Work and Proof of Stake systems, demonstrating flexibility and adaptability in different blockchain network architectures.

11. A method for optimizing blockchain transaction processing, comprising the steps of:
receiving individual cryptocurrency transactions from users and cataloging them in a Transaction Queue, where each transaction is distinctly represented as an Unspent Transaction Output (UTXO) with comprehensive details including sender and receiver identities, and transaction amount;
engaging an Active Metadata module to thoroughly analyze transaction specifics, including a calculation of the actual transaction value and data size, and continuously assessing a real-time block size availability within the blockchain network for optimal space allocation;
utilizing a sophisticated Reinforcement Learning module that applies complex, adaptive algorithms to dynamically adjust block sizes, tailored specifically to a collective size of pending transactions, thereby optimizing the transaction processing efficiency;
implementing a communication protocol between the Reinforcement Learning module and a Block Creator, designed to relay optimized transaction data for effective inclusion in blockchain blocks, ensuring maximal block utilization;
executing a transaction merging mechanism to aggregate numerous smaller transactions into a singular, larger transaction package, uniquely represented by a detailed meta hash. This meta hash encapsulates exhaustive information about all individual transactions it represents, maintaining transaction integrity while optimizing processing;
directing the Block Creator to incorporate the merged transaction into the blockchain block, with an integrated system for intelligent block space management, ensuring additional transaction accommodation by freeing up unnecessary space;
conducting a comprehensive validation of the complete blockchain block containing the merged transaction, employing a robust consensus mechanism within the blockchain network to guarantee legitimacy, accuracy, and security of the transactions; and
implementing a segregation and completion protocol in the Active Metadata module, post-block validation, meticulously designed to accurately segregate individual transactions from the merged package. Each transaction, still represented by its respective UTXO, is securely and precisely assigned to an intended recipient's wallet, finalizing the transaction cycle with integrity and accuracy.

12. The method of claim 11, wherein the step of receiving and storing transactions includes prioritizing the transactions in the Transaction Queue based on predefined criteria, including but not limited to transaction value, urgency, or user status.

13. The method of claim 12, further comprising dynamically updating the transaction processing strategy in the Active Metadata module in response to fluctuations in blockchain network conditions, such as block size availability or network congestion.

14. The method of claim 13, wherein the Reinforcement Learning module adapts its block size adjustment strategies based on historical data and performance metrics of the blockchain network.

15. The method of claim 14, further including a feedback mechanism from the Block Creator to the Reinforcement Learning module, providing insights into efficiency and success rates of block creation and transaction inclusion.

16. The method of claim 15, wherein the step of merging transactions into a larger package includes selectively combining transactions based on specific characteristics, such as transaction size, associated costs, and processing priority.

17. The method of claim 16, further comprising an automated decision-making process within the Reinforcement Learning module for optimally managing block space based on current network load and anticipated future transaction volumes.

18. The method of claim 17, including an enhanced security protocol within the validation module for detecting and mitigating fraudulent transactions during a validation phase.

19. The method of claim 18, wherein the step of segregating and completing transactions includes performing real-time audit checks to ensure accuracy in the distribution of UTXOs to the intended recipients' wallets.

20. A method for optimizing blockchain transaction processing, comprising:
receiving and storing individual cryptocurrency transactions in a Transaction Queue, each transaction characterized as an Unspent Transaction Output (UTXO) with detailed sender and receiver information;
utilizing an Active Metadata module to analyze and process each transaction, calculating the actual transaction value and size, and assessing real-time block size availability within the blockchain network;
dynamically adjusting block sizes using a Reinforcement Learning module, applying adaptive algorithms to optimize transaction processing based on collective transaction sizes and historical blockchain network data;
communicating optimized transaction data to a Block Creator for inclusion in blockchain blocks and receiving continuous updates on block creation efficiency;
merging multiple smaller transactions into a single, larger transaction package represented by a meta hash, with selective criteria including transaction size, costs, and processing priority;
issuing commands to the Block Creator to incorporate the merged transaction into a blockchain block, managing block space by freeing up unused space, and adapting to current network load and anticipated transaction volumes;
validating a completed blockchain block using a consensus mechanism, including enhanced security protocols for detecting fraudulent transactions; and
segregating individual transactions post-validation and assigning each transaction, represented by UTXO, to respective counterpart wallets, with real-time audit checks for distribution accuracy.
